(19) United States
(12) Patent Application Publication
(10) Pub. No.: US 2014/0082560 A1
(43) Pub. Date: Mar. 20, 2014

(54) IMAGE FORMING APPARATUS, METHOD FOR CONTROLLING IMAGE FORMING APPARATUS, AND COMPUTER-READABLE RECORDING MEDIUM

(71) Applicant: Konica Minolta, Inc., Tokyo (JP)

(72) Inventors: Takuya OKADA, Toyokawa-shi (JP); Yoichi KURUMASA, Toyokawa-shi (JP); Masao HOSONO, Toyokawa-shi (JP); Kenichi KOMABA, Toyokawa-shi (JP); Kazuhiro TOMIYASU, Toyokawa-shi (JP)

(73) Assignee: Konica Minolta, Inc., Tokyo (JP)

(21) Appl. No.: 14/019,985

(22) Filed: Sep. 6, 2013

(30) Foreign Application Priority Data
Sep. 19, 2012 (JP) 2012-205579

(51) Int. Cl. G06F 3/0481

(52) U.S. Cl. CPC G06F 3/04817
USPC 715/835

(57) ABSTRACT

A setting screen displayed on a display unit of an image forming apparatus includes an icon display area displaying a plurality of icons that are arranged in a predetermined direction and correspond to a plurality of function buttons for setting each function, and a function button display area displaying one or more of the plurality of function buttons. An input control unit of the image forming apparatus receives input of a group display instruction to display function buttons that belong to one of a plurality of groups in the function button display area. A display control unit of the image forming apparatus displays, in response to the input of the group display instruction, function buttons that belong to a specific group specified by the input of the group display instruction in the function button display area.

This application is based on Japanese Patent Application No. 2012-205579 filed on Sep. 19, 2012, the contents of which are hereby incorporated by reference.

### BACKGROUND OF THE INVENTION

1. Technical Field

The present invention relates to an image forming apparatus and a technique related thereto.

2. Related Art

As image forming apparatuses take on more and more functions year after year, the number of buttons (function buttons) for setting the functions of an image forming apparatus is also increasing. For this reason, it is difficult to display all function buttons corresponding to all functions on the operation panel unit (display unit) of an image forming apparatus.

Meanwhile, there is a technique for classifying a large number of function buttons into a plurality of function groups and switching among and displaying a plurality of tab screens (tab screens for the respective function groups), each including function buttons that belong to each function group. With such a tab screen switching technique, however, a plurality of function buttons that span different function groups are presented in different tab screens, and thus it is difficult to get an overview of all of a large number of function buttons.

To address the problem, Japanese Patent Application Laid-Open No. 2011-193405, for example, discloses a technique in which, among a plurality of function buttons arranged in a predetermined direction, some function buttons specified by the user are displayed in a function button display area on the display unit. Function buttons to be displayed in the function button display area can be changed by a scroll operation by the user.

To be more specific, with the technique disclosed in Japanese Patent Application Laid-Open No. 2011-193405, a setting screen including an icon display area and a function button display area is displayed on the display unit of the image forming apparatus.

In the icon display area, a plurality of icons corresponding to a plurality of function buttons for setting each function are horizontally arranged and displayed. The plurality of icons are classified into a plurality of function groups (specifically, collected in the function groups) and displayed. The icon display area is also provided with a slider for selecting some of the icons in the icon display area. Icons to be displayed in the icon display area can be specified through a user operation using the slider. To be specific, the slider includes a frame body (range specification frame) of a predetermined width that moves along with the movement of the slider, and the icons that are enclosed with the range specification frame after the slider has been moved are regarded as the specified icons.

In the function button display area, on the other hand, some function buttons that correspond to the icons specified by the user operation are displayed out of a plurality of function buttons.

With the technique disclosed in Japanese Patent Application Laid-Open No. 2011-193405, the user can easily find a desired function button while getting an overview of a large number of function buttons.

However, on the other hand, the user is required to perform an operation to move the slider closer to the desired function (or the desired function group) even if already having decided which function (function group) to set. Thus, the operation of specifying the target display area, which involves the movement of the slider, may be troublesome for a user who has already decided which function to set. It is thus desired to make the operation of setting a function simpler.

### SUMMARY OF THE INVENTION

One of objects of the present invention is to provide a technique that can improve user's operability of the setting screens of an image forming apparatus.

According to a first aspect of the present invention, an image forming apparatus includes a display unit configured to display a setting screen that includes an icon display area and a function button display area, the icon display area displaying a plurality of icons that are arranged in a predetermined direction and correspond to a plurality of function buttons for setting each function, and the function button display area displaying one or more of the plurality of function buttons, an input control unit configured to receive input of range specification for specifying some icons within a specified range of a predetermined width from among the plurality of icons arranged in the predetermined direction in the icon display area, and a display control unit configured to display some function buttons corresponding to the some icons in the function button display area in response to the input of range specification. The plurality of function buttons are classified into a plurality of groups according to their function attribute. The setting screen also includes a group display instruction area that receives input of a group display instruction to display function buttons belonging to one of the plurality of groups in the function button display area. The input control unit is also configured to receive the input of the group display instruction to the group display instruction area. The display control unit is configured to, in response to the input of the group display instruction, display function buttons that belong to a specific group specified by the input of the group display instruction, in the function button display area.

According to a second aspect of the present invention, a non-transitory computer-readable recording medium recording a program for causing a computer to execute a) displaying a setting screen that includes an icon display area, a function button display area, and a group display instruction area, the icon display area displaying a plurality of icons that are arranged in a predetermined direction and correspond to a plurality of function buttons for setting each function, the function button display area displaying one or more of the plurality of function buttons, and the group display instruction area receiving input of a group display instruction to display function buttons that belong to one of a plurality of groups for classifying the plurality of function buttons, in the function button display area, b) receiving the input of the group display instruction to the group display instruction area in a first display state in which some function buttons that correspond to some icons within a specified range of a predetermined width among the plurality of icons arranged in the predetermined direction in the icon display area are displayed in the function button display area, and c) in response to the input of the group display instruction, performing a transition operation of causing a transition to a second display state in which function buttons belonging to a specific group specified by the input of the group display instruction are displayed in the function button display area.

According to a third aspect of the present invention, a method for controlling an image forming apparatus includes a) displaying a setting screen that includes an icon display area, a function button display area, and a group display instruction area, the icon display area displaying a plurality of icons that are arranged in a predetermined direction and correspond to a plurality of function buttons for setting each function, the function button display area displaying one or more of the plurality of function buttons, and the group display instruction area receiving input of a group display instruction to display function buttons that belong to one of a plurality of groups for classifying the plurality of function buttons, in the function button display area, b) receiving the input of the group display instruction to the group display instruction area in a first display state in which some function buttons that correspond to some icons within a specified range of a predetermined width among the plurality of icons arranged in the predetermined direction in the icon display area are displayed in the function button display area, and c) in response to the input of the group display instruction, performing a transition operation of causing a transition to a second display state in which function buttons belonging to a specific group specified by the input of the group display instruction are displayed in the function button display area.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a functional block diagram showing a configuration of an image forming apparatus.

FIG. 2 shows a setting screen (first display state).

FIG. 3 illustrates classification of a plurality of functions.

FIG. 4 shows a setting screen (second display state).

FIG. 5 is a flowchart of operations performed by the image forming apparatus upon press of a group specification button.

FIG. 6 is a flowchart of operations performed by the image forming apparatus upon user operation on an icon display area.

FIG. 7 shows that a group specification button is highlighted.

FIG. 8 shows that other function buttons are grayed out.

FIG. 9 shows that function buttons belonging to a specific group and the other function buttons are displayed in different sizes.

FIG. 10 shows that the function buttons belonging to a specific group and the other function buttons are displayed in different shapes.

FIG. 11 shows that the function buttons belonging to a specific group and the other function buttons are displayed in a vertically displaced manner.

FIG. 12 illustrates a mode in which function name display areas are used as the group specification buttons.

FIG. 13 is shows that the function name display areas are provided below a string of icons in the icon display area.

FIG. 14 shows a setting screen including a plurality of group specification areas.

FIG. 15 is a flowchart of operations according to a variation.

FIG. 16 shows a dialog screen superimposed on the setting screen.

### DETAILED DESCRIPTION OF THE PREFERRED EMBODIMENTS

Hereinafter, an embodiment of the present invention will be described with reference to the drawings.

### 1. Configuration

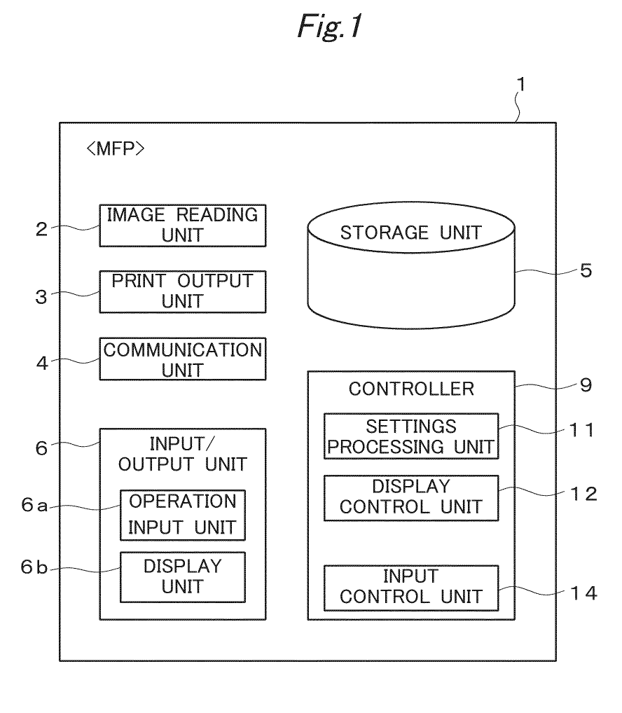

FIG. 1 is a functional block diagram showing a configuration of an image forming apparatus 1. In the present embodiment, the image forming apparatus 1 is configured as a Multi-Function Peripheral (also referred to simply as an “MFP”). The MFP is an apparatus (also referred to as a “Multi-Functional Peripheral”) having various functions such as a scan function, a print function, a copy function, and a facsimile function.

As illustrated in FIG. 1, the image forming apparatus 1 includes, for example, an image reading unit 2, a print output unit 3, a communication unit 4, a storage unit 5, an input/output unit 6, and a controller 9, and implements various functions by operating these units in combination.

The image reading unit 2 is a processing unit configured to optically read an original document placed at a predetermined position on the image forming apparatus 1 and generate image data for the original document (also referred to as an “original image”).

The print output unit 3 is an output unit configured to print out an image on various types of media such as paper on the basis of image data for an image to be printed.

The communication unit 4 is a processing unit capable of facsimile communication via a public network or the like. The communication unit 4 is also capable of network communication via a network. In the network communication, various types of protocols such as the Transmission Control Protocol/Internet Protocol (TCP/IP) and the File Transfer Protocol (FTP) are used. Using the network communication allows the image forming apparatus 1 to exchange various types of data with a desired party.

The storage unit 5 is configured by a storage device such as a hard disk drive (HDD) or a nonvolatile memory.

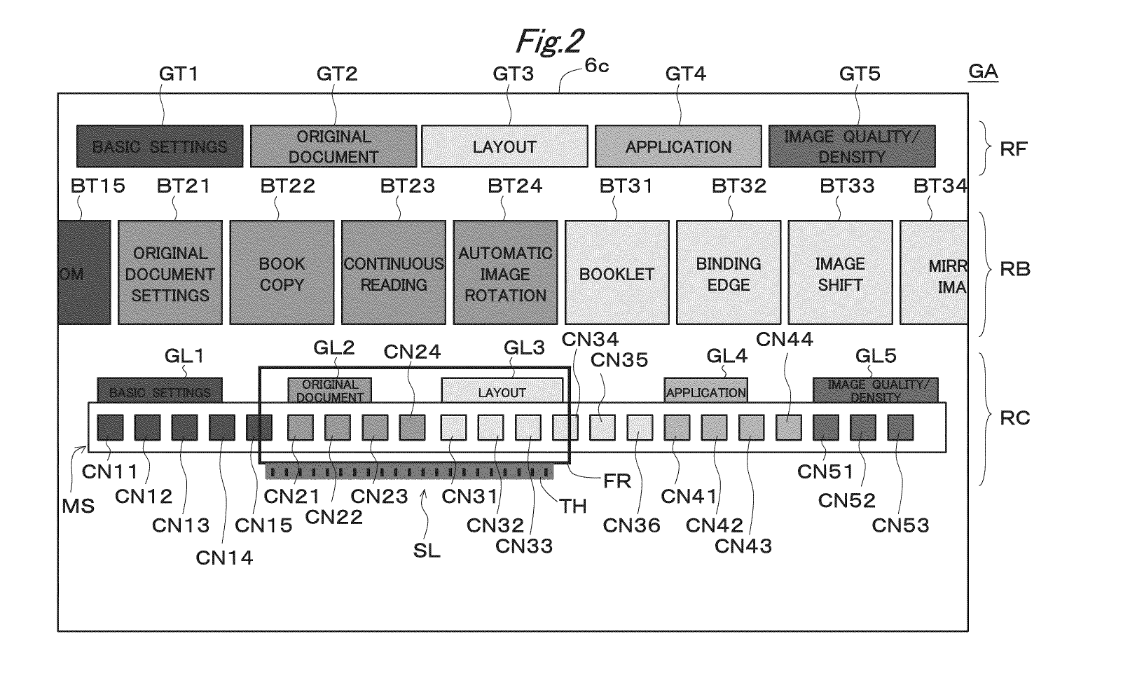

The input/output unit 6 includes an operation input unit 6a configured to receive input to the image forming apparatus 1, and a display unit 6b configured to display and output various types of information. Specifically, the image forming apparatus 1 is provided with an operation panel unit 6p (not shown) that functions as the input/output unit 6. The operation panel unit 6p includes various types of hardware keys and a touch screen 6c (see FIG. 2).

The touch screen 6c is configured by embedding piezoelectric sensors or the like in a liquid crystal display panel and functions not only as part of the display unit 6b but also as part of the operation input unit 6a. To be specific, the touch screen 6c is capable of displaying various types of information on the liquid crystal display panel and is also capable of detecting the position of an operator's finger on the liquid crystal display panel and receiving input of various types of information. For example, an operation of the operator touching a (virtual) button displayed on the touch screen 6c with his/her finger is regarded as pressing of the button.

As described above, the input/output unit 6 is capable of receiving operations input by the operator.

The controller 9 is a control unit configured to perform overall control of the image forming apparatus 1, and includes, for example, a CPU and various types of semiconductor memories (e.g., a RAM and a ROM). The various functions of the image forming apparatus 1 are implemented by various types of processing units operating under the control of the controller 9. The controller 9 implements various types of processing units by the CPU executing a predetermined software program (hereinafter, also referred to simply as a “program”) PG stored in the ROM (e.g., an EEPROM). Note that the program PG may be acquired by being downloaded through a network or may be acquired via various types of portable recording media (or in other words, various types of non-transitory computer-readable recording media) such as a USB memory.

Specifically, the controller 9 implements various types of processing units including a setting processing unit 11, a display control unit 12, and an input control unit 14.

The setting processing unit 11 is a processing unit configured to set various types of functions in the image forming apparatus 1, using setting screens or the like displayed on the touch screen 6c.

The display control unit 12 is a processing unit configured to control display operations to display various types of screens on the touch screen 6c.

The input control unit 14 is a processing unit configured to receive input of instructions from the user. Specifically, the input control unit 14 receives input of instructions from the user via various types of operational elements (e.g., a slider SL, group specification buttons GT, or function buttons BT) that are displayed on the touch screen 6c or the like.

### 2. Display Screen GA

FIG. 2 shows a setting screen (specifically, a menu screen for setting) GA displayed on the touch screen 6c.

In the initial state of the image forming apparatus 1, a setting screen GA as shown in FIG. 2 is displayed on the touch screen 6c of the image forming apparatus 1.

The setting screen GA includes an icon display area RC and a function button display area RB. The icon display area RC and the function button display area RB are each an elongated area (strip-shaped area) extending in a horizontal direction. The icon display area RC is provided below the function button display area RB on the touch screen 6c. In other words, the function button display area RB is provided above the icon display area RC on the touch screen 6c. As will be described later, the content displayed in the function button display area RB is changed according to an operation or the like performed on the icon display area RC.

In the icon display area RC, a plurality of icons CN corresponding to a plurality of function buttons BT for setting each function are horizontally arranged and displayed. In the icon display area RC, the plurality of icons CN are displayed classified into a plurality of function groups (also referred to simply as “groups”) (specifically, collected in the function groups) according to their function.

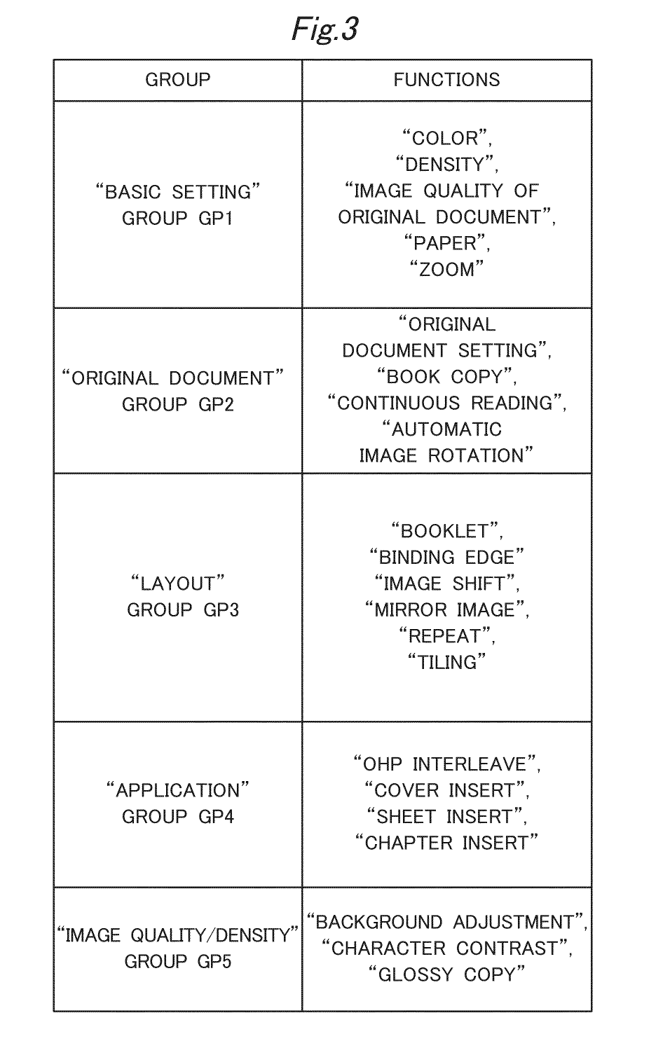

The present embodiment describes a mode in which a plurality of (in this example, a total of 22) functions are classified into a plurality of (in this example, five) groups GP1 to GP5 (a “basic setting” group, an “original document” group, a “layout” group, an “application” group, and an “image quality/density” group) according to their attribute. Specifically, as shown in FIG. 3, the “basic setting” group GP1 includes five functions (“color,” “density,” “image quality of original document,” “paper,” and “zoom”). The “original document” group GP2 includes four functions (“original document settings,” “book copy,” “continuous reading,” and “automatic image rotation”). The “layout” group GP3 includes six functions (“booklet,” “binding edge,” “image shift,” “mirror image,” “repeat,” and “tiling”). The “application” group GP4 includes four functions (“OHP interleave,” “cover insert,” “sheet insert,” and “chapter insert”), and the “image quality/density” group GP5 includes three functions (“background adjustment,” “character contrast,” and “glossy copy”).

As a result of this classification, the total of 22 function buttons BT are also classified (categorized) into the groups GP1 to GP5 according to the attribute of the corresponding function. Likewise, the total of 22 icons CN corresponding to the total of 22 functions are also classified (categorized) into the groups GP1 to GP5 according to the attribute of the corresponding function. The groups GP1 to GP5 are also referred to as “groups for classifying function buttons (and icons)” or “groups into which the function buttons (and icons) are classified”.

In the icon display area RC, the total of 22 icons CN corresponding to the aforementioned 22 functions are displayed such that they are arranged substantially linearly in the horizontal direction and are collected in the function groups. For example, five icons CN11 to CN15 on the left edge of the icon display area RC correspond respectively to the five functions of the basic setting group GP1 (i.e., “color”, “density”, “image quality of original document”, “paper”, and “zoom”). On the right side of the icons CN11 to CN15 are four icons CN21 to CN24 that correspond respectively to the four functions of the original document group GP2. Likewise, on the right side of the icons CN21 to CN24 are six icons CN31 to CN36 that correspond respectively to the six functions of the layout group GP3. On the right side of the CN31 to CN36 are four icons CN41 to CN44 that correspond respectively to the four functions of the application group GP4 and three icons CN51 to CN53 that correspond respectively to the three functions of the image quality/density group GP5, which are horizontally arranged in the order stated. In this way, the total of 22 icons CN are classified (categorized) into a plurality of groups according to the attribute of the function of the corresponding function button BT and are displayed in the icon display area RC.

The icon display area RC also includes a plurality of function name display areas GL1 to GL5. Each function name display area GLi is disposed in the vicinity (to be more specific, in the upper vicinity) of icons that correspond to the functions of the function name display area GLi among the plurality of icons CN arranged in the icon display area RC. That is, each function name display area GLi is disposed in the upper vicinity of the corresponding icons CN. For example, the function name display area GL1 is disposed in the vicinity of an icon group CN 1 (CN11 to CN15) corresponding to the group GP1, and the function name display area GL2 is disposed in the vicinity of an icon group CN2 (CN21 to CN24) corresponding to the group GP2. The other function name display areas GL3 to GL5 are also disposed in the same manner.

The icon display area RC is also provided with a slider SL for selecting some of the icons CN displayed in the icon display area RC. The slider SL has a range specification frame FR and a slider bar TH. The user can move the slider SL in the right-left direction (horizontal direction) by pressing and dragging the slider bar TH (drag operation). The range specification frame FR of a predetermined width (e.g., a width in which eight to nine icons can be arranged) also moves along with the movement of the slider SL. By moving the range specification frame FR, the user can change (specify) a range to be displayed in the function button display area RB. To be specific, the function buttons BT corresponding to the icons within the range (specified range) enclosed with the moved range specification frame FR are newly specified as buttons to be displayed in the function button display area RB.

For example, in FIG. 2, the icon CN 15 on the right edge of the basic setting group GP1, the four icons CN21 to CN24 of the original document group GP2, and the four icons CN31 to CN34 on the left edge of the layout group GP3 are enclosed with the range specification frame FR. At this time, function buttons corresponding to these icons specified by the range specification frame FR are displayed in the function button display area RB. Specifically, a function button BT15 of the basic setting group GP1, four function buttons BT21 to BT24 of the original document group GP2, and four function buttons BT31 to BT34 of the layout group GP3 are displayed in the function button display area RB. Note that only approximately half of the function buttons BT15 and BT34 at the opposite ends are displayed in FIG. 2 because the range specification frame FR encloses only approximately half of the icons CN15 and CN34 at the opposite ends.

In this manner, among all of the function buttons BT, some function buttons BT15, BT21 to BT24, and BT31 to BT35 are displayed in the function button display area RB. To be more specific, first, the user specifies some of all of the icons displayed in the icon display area RC by moving the slider SL (specifically, the range specification frame FR). Such operation input, specifically, input of an operation to specify some of all of the icons arranged horizontally in the icon display area RC, using the range specification frame FR (input of range specification) is received by the input control unit 14. Then, the display control unit 12 displays some function buttons BT15, BT21 to BT24, and BT31 to BT35 corresponding to the icons specified by the input of range specification in the function button display area RB. This operation is also referred to as, for example, an operation of scrolling the function buttons BT to be displayed in the function button display area RB by moving the range specification frame FR relative to the entire map represented by the string of icons in the icon display area RC (or also referred to as a “map scroll operation”).

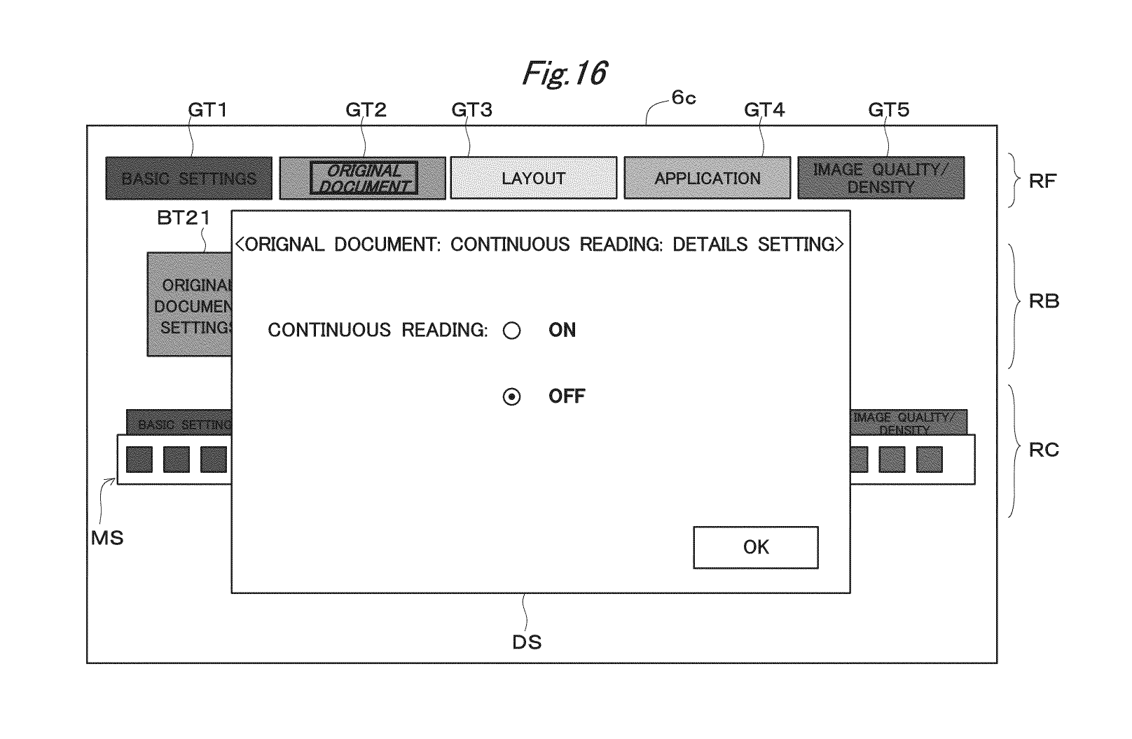

When one of the function buttons in the function button display area RB is pressed, the image forming apparatus 1 (the setting processing unit 11 and the display control unit 12) displays a dialog screen DS for setting details of the pressed function button (see FIG. 16). FIG. 16 shows a condition immediately after the function button BT23 has been pressed. After a detail setting operation using the dialog screen DS is complete, the dialog screen DS is hidden and the display returns to the original setting screen (FIG. 2).

As described above, function buttons BT are selectively displayed in the function button display area RB in accordance with the map scroll operation performed on the icon display area RC (the scroll operation performed on the entire map represented by the string of icons). The icon display area RC (including the string of icons and the slider SL) that performs the map scroll operation is also referred to as a “map stroller” (MS).

The setting screen GA also includes a group display instruction area (also referred to as a “group specification button display area”) RF. The group display instruction area RF is an area for receiving input of an operation to display function buttons BT that belong to one of the groups GP1 to GP5 in the function button display area RB (also referred to as “input of a group display instruction”).

The group display instruction area RF is an elongated area (strip-shaped area) extending in the horizontal direction and is provided above the function button display area RB independently of (separately from) both of the function button display area RB and the icon display area RC. The group display instruction area RF includes a plurality of buttons (also referred to as “group specification buttons”) GT for specifying (selecting) a desired group from among the plurality of groups. In this example, five group specification buttons GT1 to GT5 are disposed in the group display instruction area RF. The group specification buttons GT1 to GT5 are buttons for specifying their corresponding groups GP1 to GP5 as a group to be displayed. In other words, each group specification button GT is used to provide input of a group display instruction to display function buttons that belong to the corresponding specific group in the function button display area RB. For example, the group specification button GT2 is a button for providing an instruction to display the function buttons BT belonging to the corresponding specific group GP2 in the function button display area RB.

Note that the function buttons BT may be displayed in different colors determined for each function group or may be displayed in the same color. Likewise, the icons CN and the group specification buttons GT may be displayed in different colors determined for each function group or may be displayed in the same color.

### 3. Display State Transition and Setting Screen GB after Transition

When one of the five group specification buttons GT1 to GT5 is pressed by the user, function buttons that belong to the group corresponding to the pressed group specification button GT are displayed in the function button display area RB.

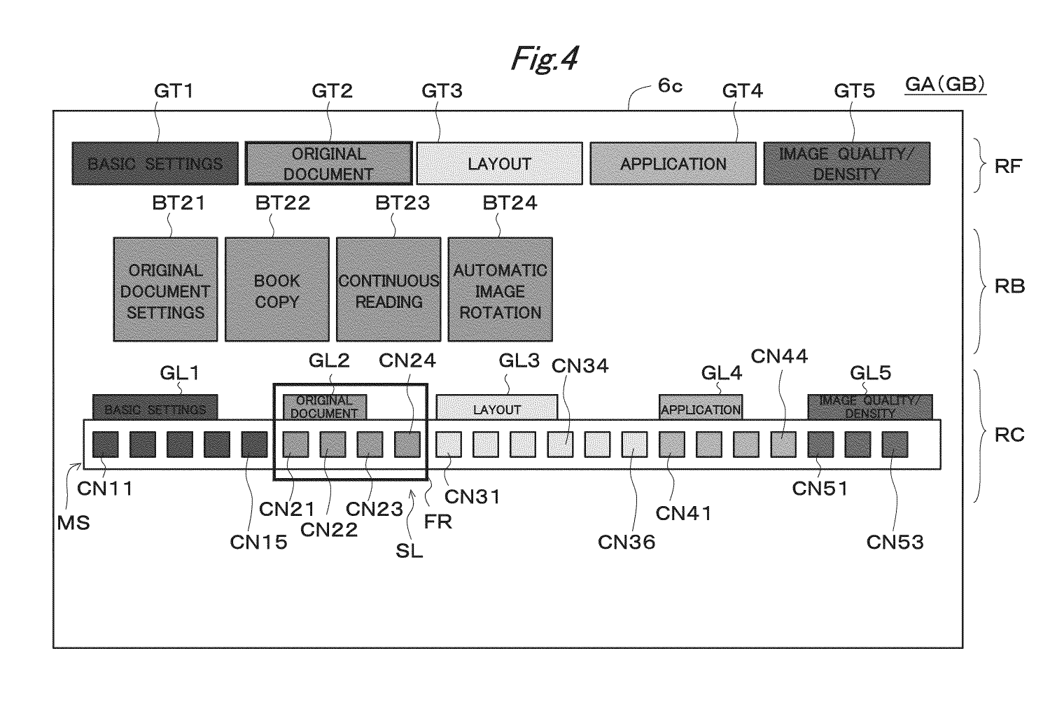

For example, when the group specification button GT2 among the five group specification buttons GT1 to GT5 is pressed, it is determined that there is input of a group display instruction to display the specific group GP2 among the plurality of groups GP1 to GP5. The setting screen GA shown in FIG. 2 transitions to a setting screen GA (also denoted by GB) shown in FIG. 4. Here, the display state of the setting screen GA shown in FIG. 2 is also referred to as a “first display state ST1” and the display state of the setting screen GA shown in FIG. 4 is also referred to as a “second display state ST2” in order to distinguish between the two states before and after the pressing of a group specification button GT (before and after input of a group display instruction).

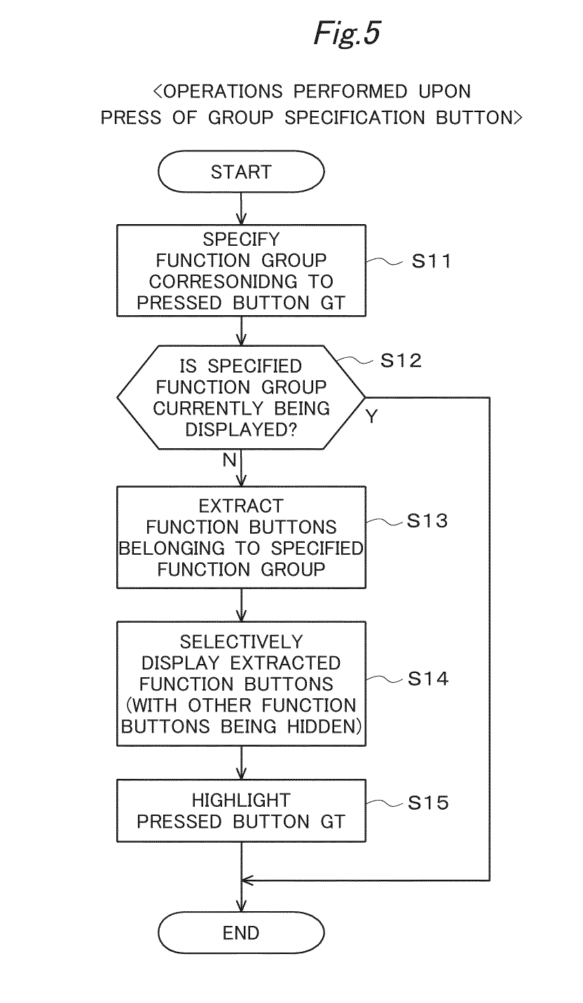

Hereinafter, the operation performed upon pressing of one of the five group specification buttons GT1 to GT5 (e.g., the group specification button GT2) will be described with reference to FIG. 5, for example. FIG. 5 is a flowchart of operations performed by the image forming apparatus 1 when a group specification button is pressed.

First, in step S11 of FIG. 5, the group (function group) corresponding to the pressed group specification button GT is identified. In step S12, it is determined whether the screen displays the function buttons belonging to the identified function group (the second display state ST2, see FIG. 4) or displays some function buttons corresponding to some icons specified by the range specification frame FR (the first display state ST1, see FIG. 2). In short, it is determined which of the setting screen GA (FIG. 2) and the setting screen GB (FIG. 4) is displayed on the touch screen 6c. The processing of steps S11 and S12 is performed by, for example, the input control unit 14.

If it is determined that the setting screen GA (FIG. 2) in the first display state ST1 is still displayed on the touch screen 6c, the procedure proceeds to step S13. To be specific, if the setting screen GA (FIG. 2) in the first display state ST1 is still displayed when the group specification button GT2 has been pressed, it is determined that input of an instruction to display function buttons that belong to one group specified from among the plurality of groups (input of a group display instruction) has been received, and the procedure proceeds to step S13.

In step S13, the function buttons belonging to the group identified in step S11 are extracted. In step S14, the extracted function buttons are displayed in the function button display area RB. In this way, in response to input of a group display instruction, (one or more) function buttons BT that belong to the specific group specified by the input of the group display instruction are displayed in the function button display area RB. In step S15, the pressed button GT is highlighted, and the display form of the slider SL in the icon display area RC is changed. The processing of steps S13 to S15 is performed by, for example, the display control unit 12.

For example, when the group (function group) GP2 corresponding to the pressed group specification button GT2 is identified in step S11, the function buttons BT21 to BT24 corresponding to the group GP2 are extracted in step S13. In step S14, the function buttons BT21 to BT24 belonging to the specific group GP2 are displayed in the function button display area RB, instead of the function buttons BT15, BT21 to BT24, and BT31 to BT35 corresponding to the icons specified by the input of range specification. That is, only the function buttons BT21 to BT24 are selectively displayed in the function button display area RB and the other buttons BT15 and BT31 to BT35 are not displayed (are hidden) in the function button display area RB. With this configuration, among all of the function buttons, only the function buttons narrowed down by “function” (the type of function) are displayed, and accordingly the user can easily find out the desired function button. In step S15, the pressed group specification button GT2 is enclosed with a bold frame for emphasis. This enables the user to easily recognize the selected button. Also, in step S15, the length and position of the range specification frame FR in the icon display area RC are changed. Specifically, the position and length of the range specification frame FR are adjusted such that the range specification frame FR encloses only the icons corresponding to the function buttons BT21 to BT24 displayed in the function button display area RB. The sliding level TH of the slider SL is also hidden.

In this way, the setting screen GA (GB) in the second display state ST2 shown in FIG. 4 is displayed on the touch screen 6c in response to the pressing of the specific group specification button GT2 among the plurality of group specification buttons (input of a group display instruction). In the second display state ST2, the function buttons BT21 to BT24 that belong to the group GP2 corresponding to the group specification button GT2 are displayed in the function button display area RB. When one of the function buttons in the function button display area RB is pressed in the setting screen GB (FIG. 4), the image forming apparatus 1 (the setting processing unit 11 and the display control unit 12) displays a dialog screen DS for setting details of the pressed function button (see FIG. 16). After the detail setting operation (user operation) using the dialog screen DS is complete, the display control unit 12 or the like causes the dialog screen DS to be hidden so that the display returns to the original screen (the setting screen GB in the second display state ST2 shown in FIG. 4).

If it is determined in step S12 that the setting screen GB (FIG. 4) is already displayed on the touch screen 6c, the processing ends immediately. For example, when the group specification button GT2 is pressed twice continuously, it is determined that the setting screen GB (FIG. 4) is already displayed (state transition from the first display state ST1 to the second display state ST2 has already ended), and no action is taken.

### 4. Screen Return

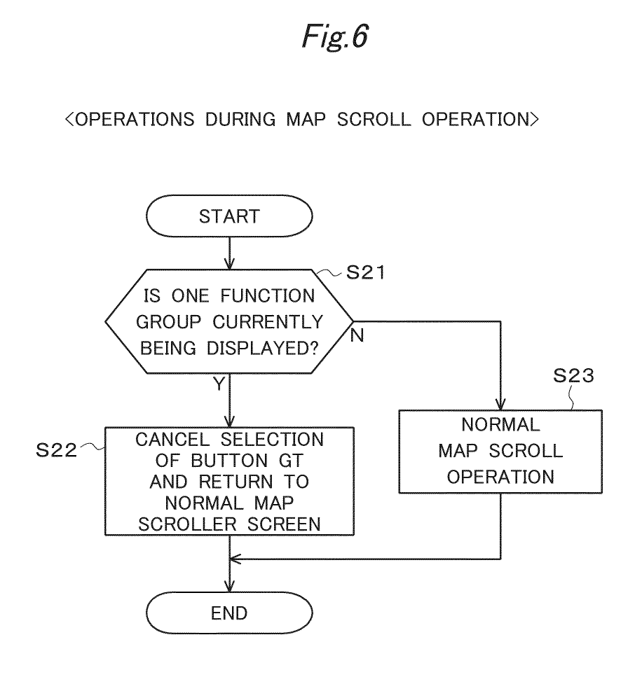

Next, a state transition operation from the second display state ST2 to the first display state ST1, or in other words, a re-transition operation from the setting screen GB (FIG. 4) to the setting screen GA (FIG. 2) will be described with reference to FIG. 6. In the present embodiment, a state transition (return operation) from the second display state ST2 to the first display state ST1 occurs upon receipt of a user operation on the icon display area RC (an operation of touching the string of icons or the slider SL (e.g., the range specification frame FR) in the icon display area RC) in the second display state ST2. FIG. 6 is a flowchart of operations performed by the image forming apparatus 1 upon user operation on the icon display area RC.

In step S21 in FIG. 6, the same determination operation as in step S12 is performed. If it is determined that the setting screen GA (GB) in the second display state ST2 is displayed on the touch screen 6c, the procedure proceeds to step S22. In step S22, the state transitions from the second display state ST2 to the first display state ST1.

Specifically, the function buttons BT15, BT21 to BT24, and BT31 to BT35 displayed in the function button display area RB in the first display state ST1 immediately before are again displayed in the function button display area RB. In other words, the function buttons BT15, BT21 to BT24, and BT31 to BT35 corresponding to the icons specified by the input of range specification are again displayed in the function button display area RB, instead of the function buttons BT21 to BT24 belonging to the specific group GP2. The group specification button GT2 is unhighlighted. The display form of the slider SL in the icon display area RC is also reverted. Specifically, the length and position of the range specification frame FR are returned to its original length and position, and the slider bar TH of the slider SL is displayed again. Through this, the setting screen GA in the first display state ST1 is displayed again on the touch screen 6c.

If, on the other hand, it is determined that the setting screen GA in the first display state ST1 (FIG. 2) is displayed on the touch screen 6c, the procedure proceeds from step S21 to step S23. In step S23, an operation is performed in accordance with a map scroll operation (a scroll operation on the entire map represented by the string of icons). Specifically, function buttons to be displayed in the function button display area RB (display target buttons) are changed in accordance with the operation of moving the slider SL (a display range specification operation using the range specification frame FR).

### 5. Advantageous Effects of Embodiments

According to the operations described above, when the group specification button GT2 is pressed in the setting screen GA, the function buttons BT21 to BT24 corresponding to the group specification button GT2 are selectively displayed in the function button display area RB. This enables the user to get an overview of all functions through a map scroll operation and to easily invoke the function buttons belonging to the desired function group without operating the slider SL. It is thus possible for the user to make settings for the desired function button through a simple operation. In particular, the user who has already known the function group that corresponds to the function to be set can attain improved operability.

In the above embodiment, the group specification buttons GT for specifying each function group are provided independently of the icon display area RC. This enables the user to visually recognize the group specification buttons GT for specifying each function group with ease. The user can thus easily perform a specification operation to specify a function group to be displayed in the function button display area RB, using the group specification buttons GT.

### 6. Variations

While the above has been a description of an embodiment of the present invention, the present invention is not intended to be limited to the content described above.

### 6-1. Group Specification Button GT

For example, the above embodiment describes a mode in which the group specification button GT2 (specifically, the outer contour line of the button) is enclosed with a bold frame for emphasis in the setting screen GA (GB) in the second display state ST2 (see FIG. 4), but the present invention is not limited thereto.

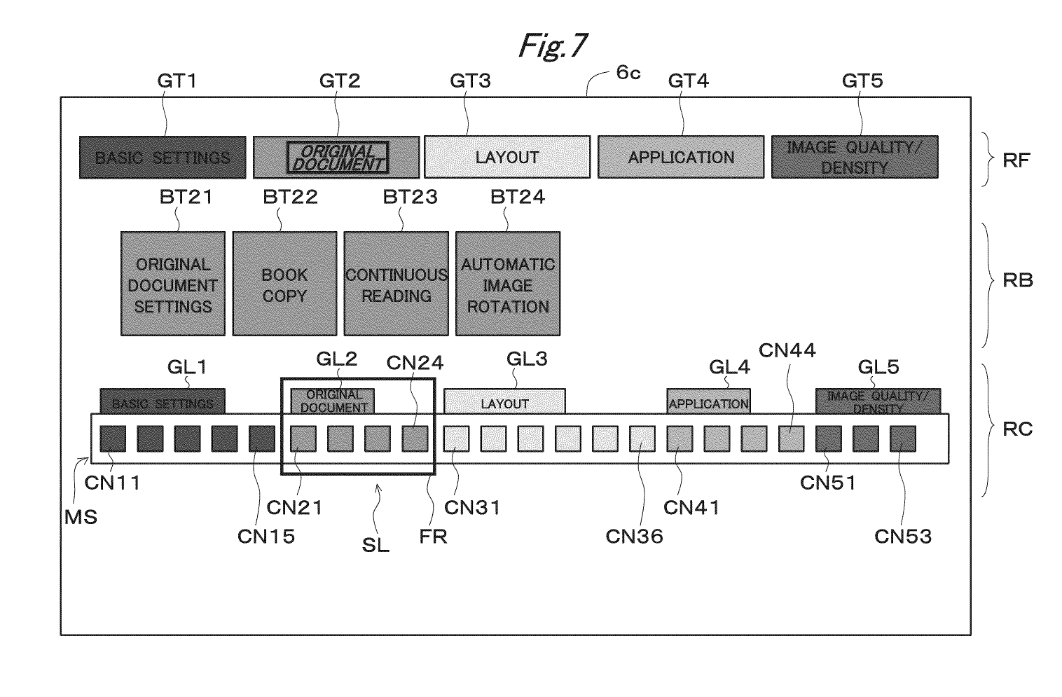

Specifically, the group specification button GT2 may be highlighted by enclosing the characters within the group specification button GT2 with a bold frame inside the outer contour line of the group specification button GT2 as shown in FIG. 7.

Alternatively, the group specification button GT2 may be highlighted by displaying characters within the group specification button GT2 in bold (and/or italic). Yet alternatively, the group specification button GT2 may be highlighted by displaying characters within the group specification button GT2 in a color (font color) different from the font color of the other group specification buttons GT1 and GT3 to GT5. Yet alternatively, the group specification button GT2 may be highlighted by displaying the group specification button GT2 itself (the background of the characters) in a color (background color) different from the color of the other group specification buttons GT1 and GT3 to GT5.

As another alternative, the other group specification buttons GT1 and GT3 to GT5 may be displayed to appear translucent (or grayed-out) while the group specification button GT2 being displayed in a normal manner. With this technique as well, it is possible to display the pressed group specification button GT2 and the other group specification buttons GT1 and GT3 to GT5 in a distinguished manner.

As described above, among the plurality of group specification buttons GT, the specific group specification button GT2 pressed by the user and the other group specification buttons GT1 and GT3 to GT5 may be displayed in different forms.

### 6-2. Function Button Display Area RB and Icon Display Area RC

In the above embodiment, only the function buttons BT21 to BT24 that belong to the specific group GP2 specified by input of a group display instruction among the plurality of (the total of 22) function buttons BT are displayed in the function button display area RB in the second display state ST2 (see FIG. 4). The present invention is, however, not limited thereto.

For example, the function buttons BT21 to BT24 that belong to the specific group GP2 and the function buttons that do not belong to the specific group GP2 may be displayed in different forms in the function button display area RB in response to input of a group display instruction.

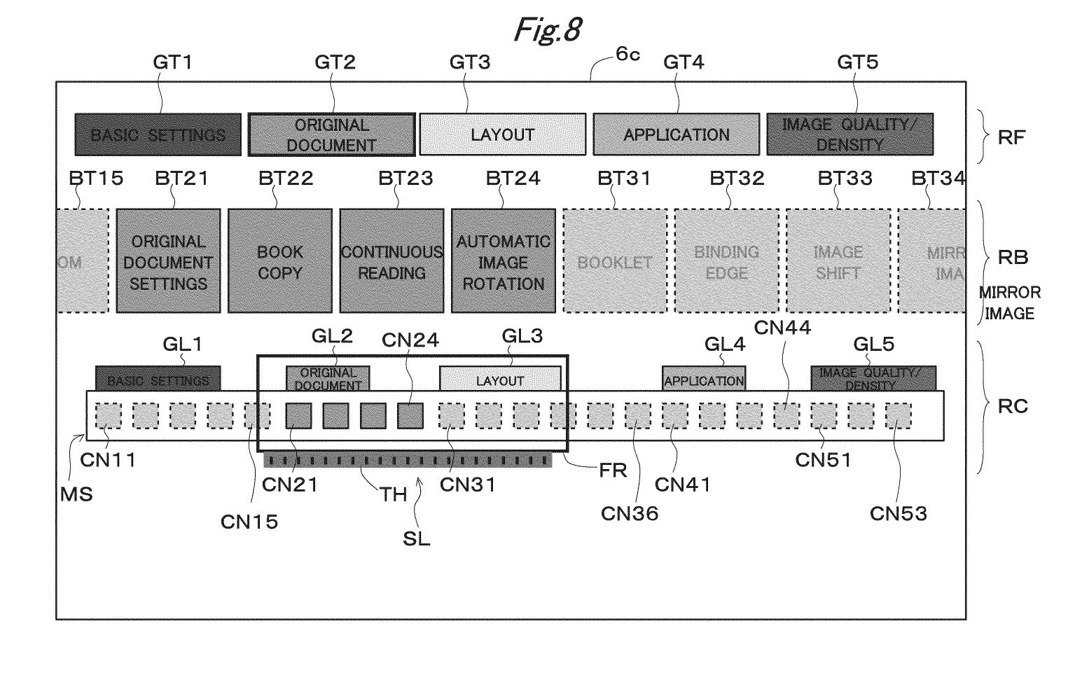

Specifically, not only the function buttons BT21 to BT24 that belong to the specific group GP2, but also the other adjacent buttons BT15 and BT31 to BT34 are displayed in the second display state ST2 as shown in FIG. 8. In FIG. 8, the function buttons BT (e.g., BT15 and BT31 to BT34) that do not belong to the specific group GP2 are grayed out (dimmed) in order to distinguish between the function buttons that belong to the specific group GP2 and the function buttons that do not belong to the specific group GP2. The present invention is, however, not limited thereto, and the function buttons BT that do not belong to the specific group GP2 may be displayed translucently.

The display form of the icons CN in the icon display area RC may be changed in the same manner as that in the function button display area RB as shown in FIG. 8 in response to the input of a group display instruction. Specifically, among the plurality of icons in the icon display area RC, the icons that belong to the specific group GP2 and the icons that do not belong to the specific group GP2 may be displayed in different forms. More specifically, in the icon display area RC, only the four icons CN21 to CN24 belonging to the group GP2 may be displayed in a normal manner, whereas the other 18 icons CN that do not belong to the group GP2 may be grayed out (dimmed). Note that these 18 icons CN may be displayed translucently.

As described above, the function button display area RB and the icon display area RC may be displayed in the form as shown in FIG. 8.

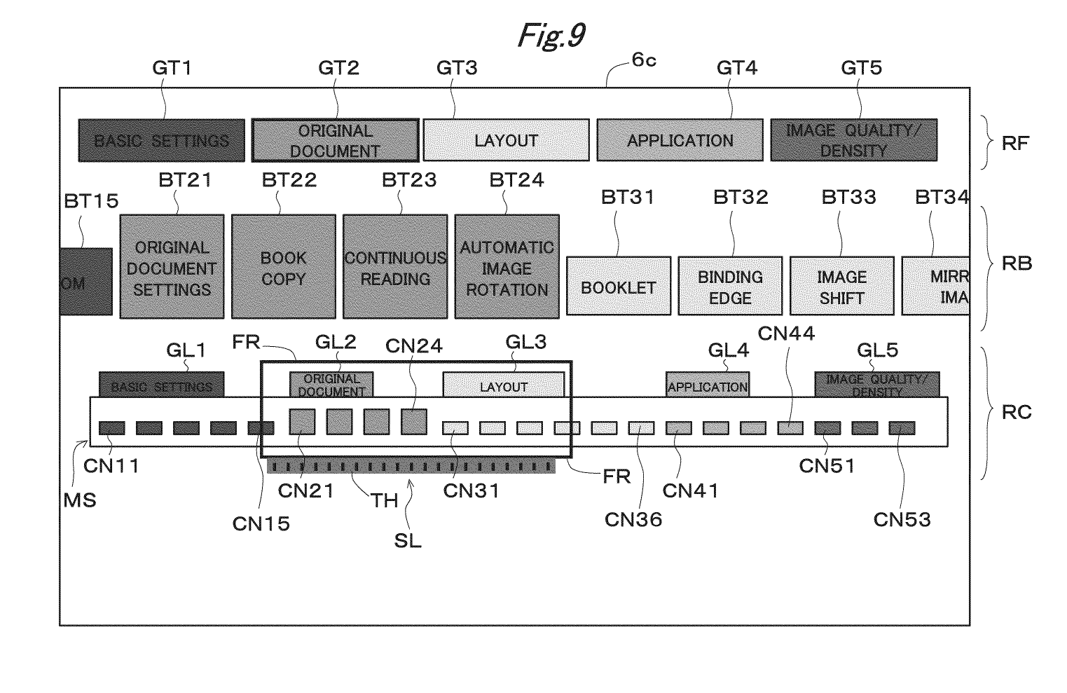

Alternatively, the function button display area RB and the icon display area RC may be displayed in a form as shown in FIG. 9 in the second display state ST2.

In FIG. 9, in response to input of a group display instruction, the shape of the function buttons BT (e.g., BT15 and BT31 to BT34) that do not belong to the specific group GP2 is changed from square to rectangle (oblong shape), the height of which is one-half the height of the function buttons BT21 to BT24. In this way, (one or more) function buttons that belong to a specific group specified by the user and the other function buttons (the function buttons that do not belong to the specific group) may be displayed in different forms (in particular, in different sizes or shapes) in the function button display area RB.

In this case, the display form of the icons CN in the icon display area RC may also be changed in the same manner as that in the function button display area RB as shown in FIG. 9. Specifically, in the icon display area RC, only the four icons CN21 to CN24 belonging to the group GP2 may be displayed in a normal manner, whereas the other 18 icons CN that do not belong to the group GP2 may be displayed as rectangular icons (oblong icons), the height of which is one-half the height of the icons CN21 to CN24.

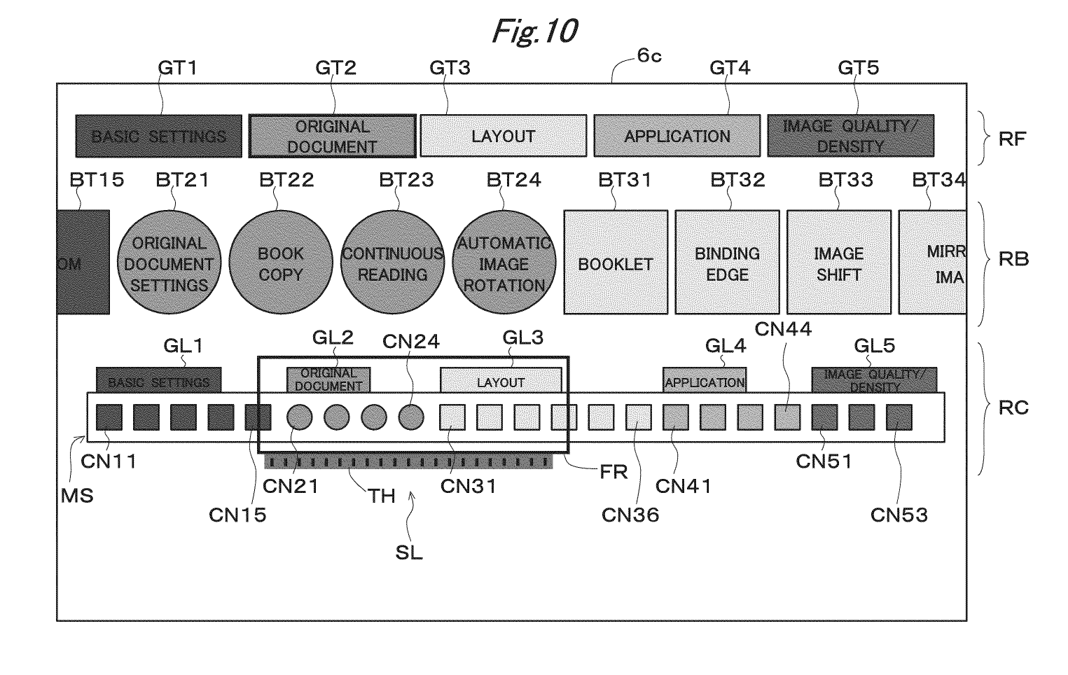

Alternatively, the function button display area RB and the icon display area RC may be displayed in a form as shown in FIG. 10 in the second display state ST2.

Specifically, the shape of the function buttons BT (e.g., BT15 and BT31 to BT34) that do not belong to the specific group GP2 remains square, whereas the shape of the function buttons BT21 to BT24 belonging to the specific group GP2 is changed to circular. In this way, (one or more) function buttons that belong to a specific group specified by the user and the other function buttons (the function buttons that do not belong to the specific group) may be displayed in different forms (in particular, in different sizes or shapes) in the function button display area RB.

In this case, the display form of the icons CN in the icon display area RC may also be changed in the same manner as that in the function button display area RB as shown in FIG. 10. Specifically, in the icon display area RC, the shape of the 18 icons CN that do not belong to the specific group GP2 may remain square, and the shape of the four icons CN21 to CN24 belonging to the specific group GP2 may be changed to circular.

Conversely, the shape of the 18 icons CN that do not belong to the specific group GP2 may be changed to circular, and the shape of the four icons CN21 to CN24 belonging to the specific group GP2 may remain square. Likewise, the shape of the shape of the four function buttons BT21 to BT24 belonging to the specific group GP2 may remain square, and the other buttons BT15 and BT31 to BT34 that do not belong to the specific group GP2 may be changed to circular. It is preferable that the buttons BT21 to BT24 and the icons CN21 to CN24 that belong to the same function group GP2 be displayed in the same shape (in order to indicate their correspondence).

As described above, two types of function button groups that are classified according to whether or not they belong to the specific group GP2 may be displayed in different shapes so as to be distinguishable from each other. Likewise, two types of icon groups that are classified according to whether or not they belong to the specific group GP2 may be displayed in different shapes so as to be distinguishable from each other. Here, although an example in which the shapes of the function buttons and the icons are circular, square or oblong is described, the present invention is not limited thereto, and the function buttons and the icons may be of other shapes (e.g., a star shape).

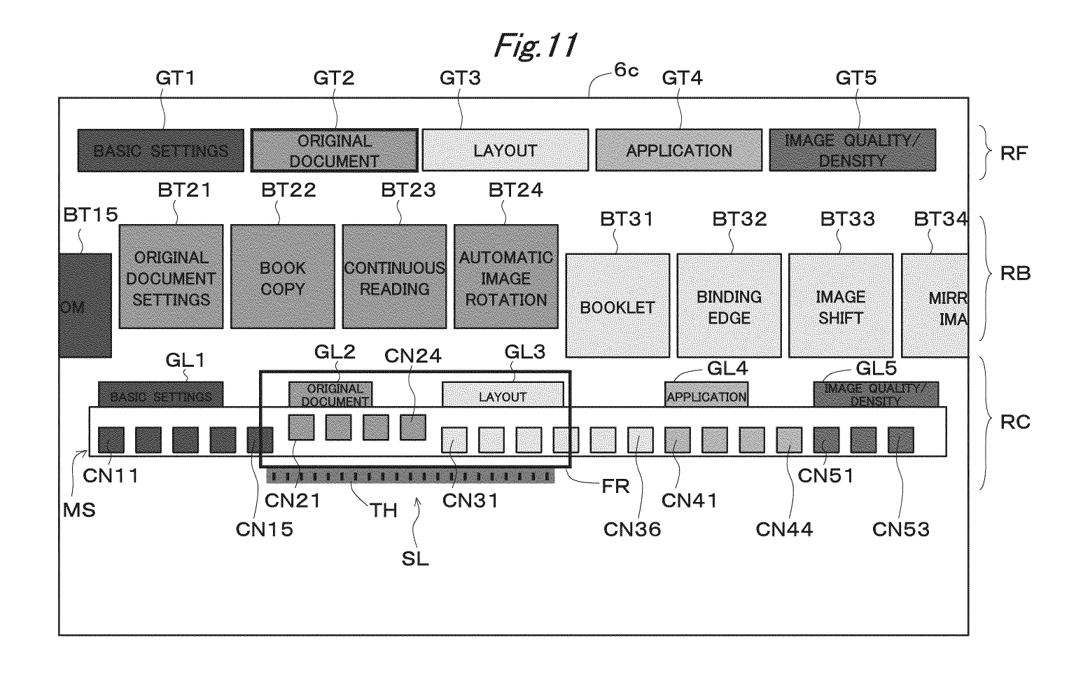

Alternatively, the function button display area RB and the icon display area RC may be displayed in a form as shown in FIG. 11 in the second display state ST2.

In FIG. 11, the positions in the height direction of the function buttons BT (e.g., BT15 and BT31 to BT34) that do not belong to the specific group GP2 are shifted to below the function buttons BT21 to BT24. In this way, among the plurality of function buttons in the function button display area RB, the function buttons BT21 to BT24 that belong to the specific group GP2 and the function buttons that do not belong to the specific group GP2 may be displayed displaced vertically (in the direction perpendicular to the horizontal direction) from each other in the function button display area RB.

In this case, the display form of the icons CN in the icon display area RC may also be changed in the same manner as that in the function button display area RB as shown in FIG. 11. Specifically, in the icon display area RC, the four icons CN21 to CN24 belonging to the group GP2 may be displayed in a normal manner, whereas the position in the height direction of the other 18 icons CN that do not belong to the group GP2 may be shifted to below the icons CN21 to CN24. That is, among the total of 22 icons in the icon display area RC, the icons CN21 to CN24 that belong to the specific group GP2 and the icons that do not belong to the specific group GP2 may be displayed vertically displaced from each other.

### 6-3. Group Display Instruction

The above embodiment describes a mode (see FIG. 2) in which a plurality of group specification buttons GT (GT1 to GT5) are disposed in the group display instruction area RF that is provided independently of both of the icon display area RC and the function button display area RB, but the present invention is not limited thereto.

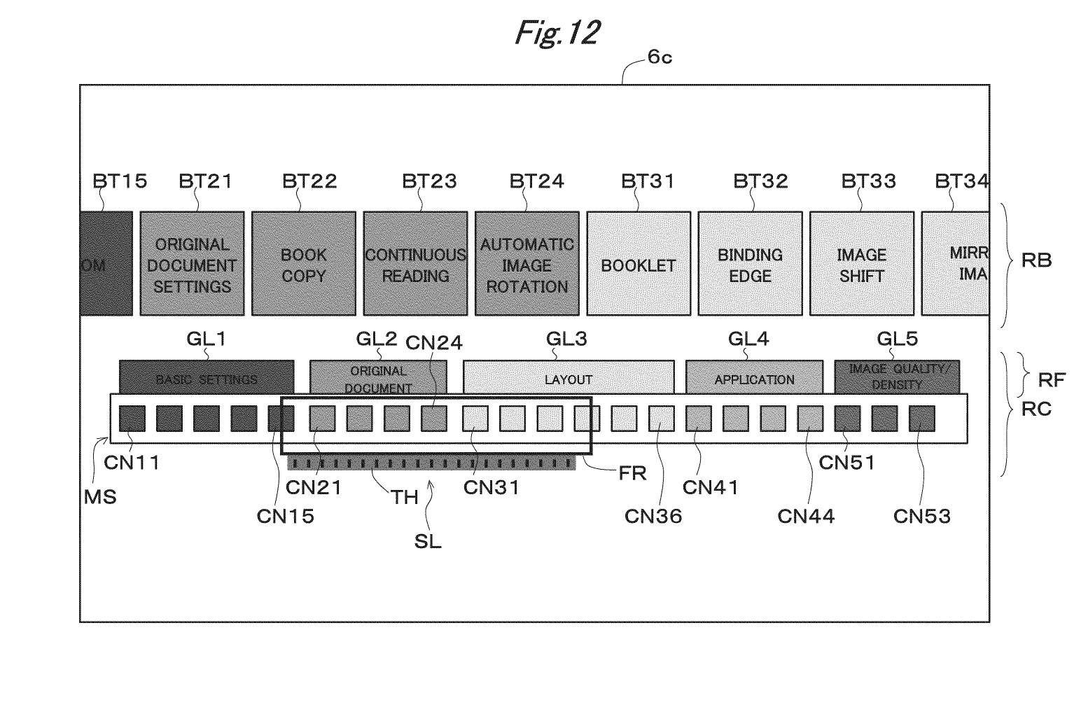

For example, the function name display areas GL in the icon display area RC may be used as the group specification buttons GT as shown in FIG. 12. Specifically, in the first display state ST1, the function name display areas GL are each disposed in the vicinity of an icon group corresponding to the function of the function name display area GL among the icons CN arranged in the icon display area RC. In FIG. 12, the independent group specification buttons GT as shown in FIG. 2 are not provided. Instead, the function name display areas GL in FIG. 12 each have a function of receiving input of a group display instruction and are each used as a group specification button GT. In the mode shown in FIG. 12, the group display instruction area RF including the function name display areas GL is provided in the icon display area RC.

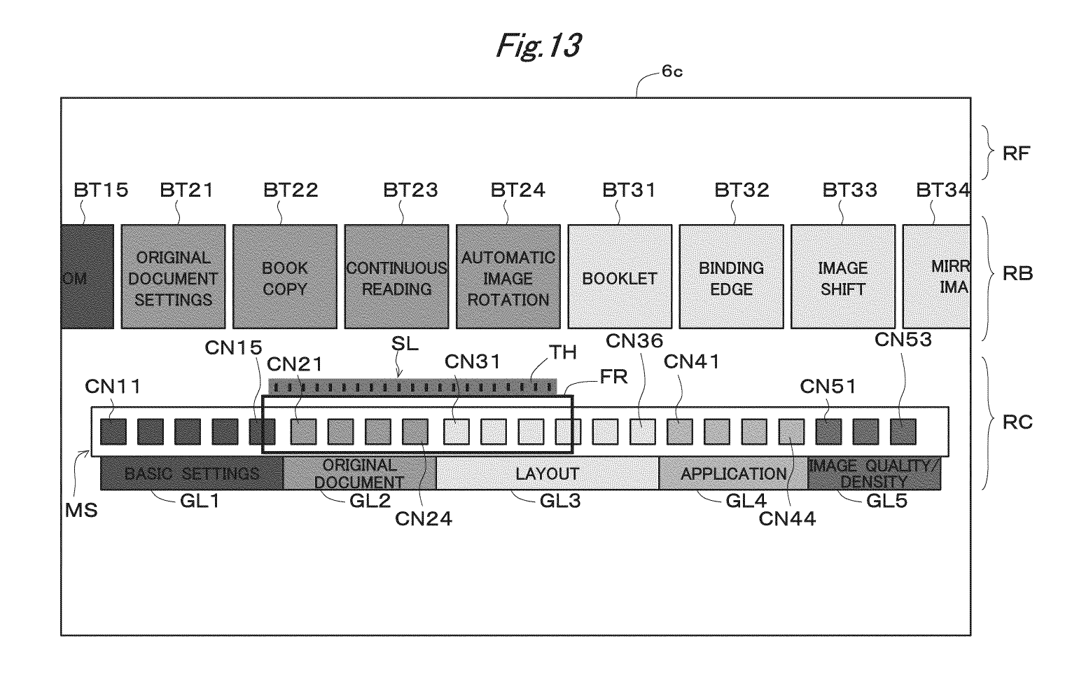

Although FIG. 12 shows a mode in which the function name display areas GL are disposed above the string of icons in the icon display area RC, the present invention is not limited thereto. For example, the function name display areas GL may be disposed below the string of icons in the icon display area RC and may be used as the group specification buttons GT as shown in FIG. 13. The function name display areas GL may be disposed independently of (separately from) each other as shown in FIG. 12 or may be continuously disposed in contact with each other in the right-left direction (in the direction in which they are disposed adjacent) as shown in FIG. 13.

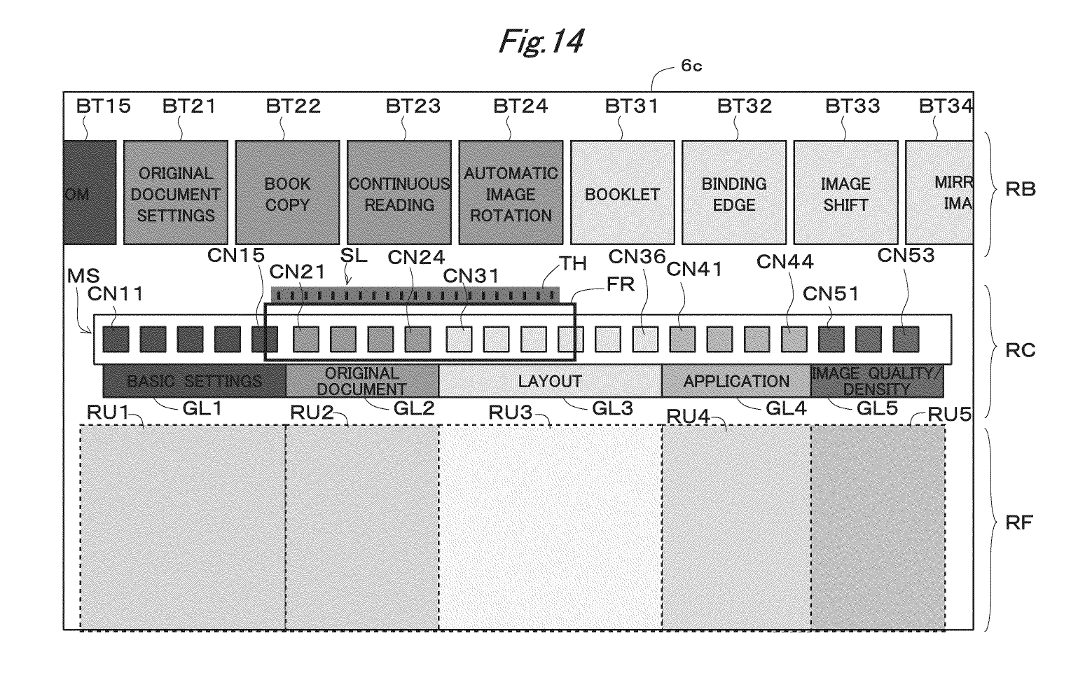

Alternatively, a function group to be displayed in the function button display area RB may be specified through an operation performed on a plurality of group specification areas RU (RU1 to RU5) as shown in FIG. 14. FIG. 14 shows a setting screen in the first display state ST1. The group specification areas RU are areas that divide the group display instruction area RF and that is for specifying each of the groups GP as a group to be displayed. In this example, the group specification areas RU (RU1 to RU5) are provided as areas that (horizontally) divide the group display instruction area RF according to the width of each function in the icon group in the icon display area RC. The group display instruction area RF is disposed below the icon display area RC.

More specifically, in response to an operation of touching a group specification area, the function group corresponding to the touched group specification area may be determined as a group to be displayed in the function button display area RB. For example, the image forming apparatus 1 may be configured to, when a touch operation on the group specification area RU2 with a user's finger is detected, specify a function group (GP2) corresponding to the group specification area RU2 and display the function buttons BT21 to BT24 that belong to the function group GP2 in the function button display area RB.

In the case where a function group to be displayed in the function button display area RB is specified using the group specification areas RU (RU1 to RU5) as shown in FIG. 14, the group specification area RU2 specified by user operation and the other group specification areas RU1 and RU3 to RU5 may be displayed in different forms. For example, two types of areas, namely, the specific group specification area RU2 and the other group specification areas RU1 and RU3 to RU5, may be displayed in different colors (background colors) (color-coded). Alternatively, the group specification area RU2 may be displayed in a normal manner, and the other group specification areas RU1 and RU3 to RU5 may be displayed translucently (or grayed out).

### 6-4. Cancellation of Group Display

The above embodiment describes a mode in which the setting screen GB (in the second display state ST2) is displayed in response to pressing of a group specification button GT, and the setting screen GA (in the first display state ST1) is displayed again in response to a pressing operation performed on the icon display area RC, but the present invention is not limited thereto.

For example, when the setting screen GB is displayed in response to pressing of a group specification button GT and the group specification button GT is again pressed thereafter, the setting screen GA may be again displayed in response to the re-pressing of the group specification button GT. In short, the setting screen GB and the setting screen GA may be displayed alternately each time a group specification button GT is pressed. In other words, a state transition between the first display state ST1 and the second display state ST2 may occur each time a group specification button GT is pressed.

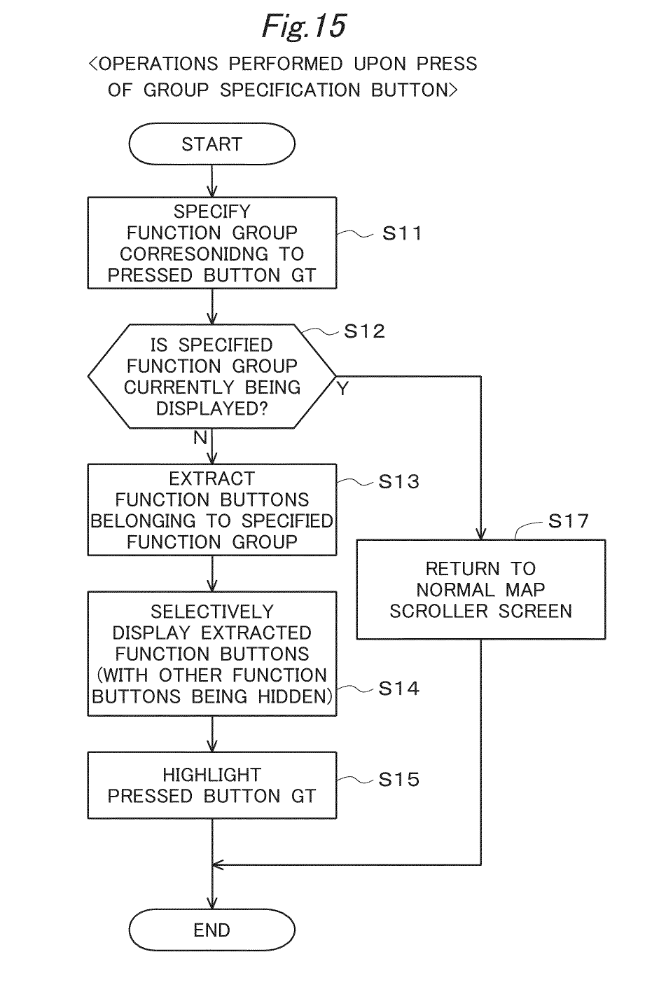

FIG. 15 is a flowchart of such operations. The operations in FIG. 15 differ from those in FIG. 5 in that the procedure proceeds from step S12 to step S17 if it is determined in the determination processing of step S12 that a specific function group is being selectively displayed (the setting screen GB (FIG. 4) is being displayed). In step S17, an operation to change the setting screen GB (FIG. 4) back to the setting screen GA (FIG. 2) (a transition from the second display state ST2 to the first display state ST1) is performed. More specifically, an operation to return the function button display area RB and the icon display area RC to the display form as shown in FIG. 2 is performed. This allows some function buttons corresponding to some icons specified by input of range specification to be displayed again in the function button display area RB.

Alternatively, a transition operation from the setting screen GB (FIG. 4) to the setting screen GA (FIG. 2) (a return operation to a normal map stroller screen), or in other words, a transition operation from the second display state ST2 to the first display state ST1 may be performed after the detail setting operation involved in the pressing of a function button BT (see FIG. 16) is complete.

FIG. 16 shows a condition immediately after pressing of the function button BT23 (continuous reading setting button) among the function buttons BT21 to BT24 in a state (see FIG. 4) in which the function buttons BT21 to BT24 belonging to the specific group GP2 are displayed in the function button display area RB. When one of the function buttons (a function button for a specific function that belongs to the specific group GP2) is pressed in the function button display area RB, the image forming apparatus 1 (the display control unit 12) displays a detail setting screen for the pressed function button in response to the pressing of the function button. For example, the dialog screen (detail setting screen) DS for the pressed function button BT23 is displayed in FIG. 16. The dialog screen DS is a screen for setting details of the function “continuous reading” corresponding to the function button BT23. The dialog screen DS is displayed superimposed on the setting screen GB (see FIG. 4) in a center portion of the touch screen 6e. In the dialog screen DS, a function setting operation of setting the function “continuous reading” (e.g., an operation of setting “continuous reading” to “ON” and pressing the OK button) is performed by the user. At this time, in response to completion of the function setting operation (user operation), the display control unit 12 may cause the dialog screen DS to be hidden and cause the display state of the touch screen 6c to transition to the first display state ST1 (see the setting screen GA in FIG. 2), instead of causing the display state to return to the second display state ST2 (see the setting screen GB in FIG. 4).

Alternatively, a transition operation from the setting screen GB (FIG. 4) to the setting screen GA (FIG. 2) (return operation) may be performed if the no-operation period continues for a predetermined period of time. More specifically, if no user operation is performed on the image forming apparatus 1 (specifically, the touch screen 6c) for a predetermined period of time (e.g., 3 minutes) after the screen transitioned from the setting screen GA (FIG. 2) to the setting screen GB (FIG. 4), a screen transition operation from the setting screen GB (FIG. 4) to the setting screen GA (FIG. 2) (return operation) may be performed. This allows the image forming apparatus 1 to, when one user gets away from the image forming apparatus 1, automatically and appropriately prepare for being used by another user.

### 6-5. Other Embodiments

Although the above embodiment describes an MFP (Multi-Functional Peripheral) as an example of the image forming apparatus 1, the present invention is not limited thereto. For example, the image forming apparatus 1 may be configured as various types of single-function apparatuses (e.g., a copy apparatus, a printing apparatus, or a scanner apparatus).

The present invention may be embodied in various other forms without departing from the spirit or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

What is claimed is:

1. An image forming apparatus comprising:
a display unit configured to display a setting screen that includes an icon display area and a function button display area, the icon display area displaying a plurality of icons that are arranged in a predetermined direction and correspond to a plurality of function buttons for setting each function, and the function button display area displaying one or more of the plurality of function buttons;
an input control unit configured to receive input of range specification for specifying some icons within a specified range of a predetermined width from among the plurality of icons arranged in the predetermined direction in the icon display area; and
a display control unit configured to display some function buttons corresponding to the some icons in the function button display area in response to the input of range specification,
wherein the plurality of function buttons are classified into a plurality of groups according to their function attribute,
the setting screen also includes a group display instruction area that receives input of a group display instruction to display function buttons belonging to one of the plurality of groups in the function button display area,
the input control unit is also configured to receive the input of the group display instruction to the group display instruction area, and
the display control unit is configured to, in response to the input of the group display instruction, display function buttons that belong to a specific group specified by the input of the group display instruction, in the function button display area.

2. The image forming apparatus according to claim 1, wherein
a plurality of group specification buttons for specifying each of the plurality of groups as the specific group are disposed in the group display instruction area.

3. The image forming apparatus according to claim 2, wherein
the plurality of group specification buttons are disposed in the group display instruction area that is provided independently of both of the icon display area and the function button display area.

4. The image forming apparatus according to claim 2, wherein
the plurality of group specification buttons are each disposed in a vicinity of a group of icons that correspond to a function of the group specification button among the plurality of icons arranged in the icon display area.

5. The image forming apparatus according to claim 2, wherein
the display control unit is configured to, when function buttons belonging to the specific group are displayed in the function button display area in response to pressing of a specific group specification button among the plurality of group specification buttons, display the specific group specification button pressed by a user and the other group specification buttons other than the specific group specification button among the plurality of group specification buttons in different forms.

6. The image forming apparatus according to claim 1, wherein
the group display instruction area is divided into a plurality of group specification areas for specifying each of the plurality of groups as the specific group.

7. The image forming apparatus according to claim 1, wherein
the display control unit is configured to, upon receiving the input of the group display instruction to the specific group among the plurality of groups, display only function buttons that belong to the specific group among the plurality of function buttons, in the function button display area.

8. The image forming apparatus according to claim 1, wherein
the display control unit is configured to, upon receiving the input of the group display instruction to the specific group among the plurality of groups, display function buttons that belong to the specific group and function buttons that do not belong to the specific group in different forms in the function button display area.

9. The image forming apparatus according to claim 8, wherein
the display control unit is configured to, upon receiving the input of the group display instruction to the specific group among the plurality of groups, display icons that belong to the specific group and icons that do not belong to the specific group among the plurality of icons in the icon display area in different forms.

10. The image forming apparatus according to claim 1, wherein
the display control unit is configured to, upon receiving the input of the group display instruction to the specific group among the plurality of groups, display function buttons that belong to the specific group and function buttons that do not belong to the specific group, in the function button display area in such a manner that the function buttons belonging to the specific group and the function buttons that do not belong to the specific group are displaced from each other in a direction perpendicular to the predetermined direction.

11. The image forming apparatus according to claim 10, wherein
the display control unit is configured to, upon receiving the input of the group display instruction to the specific group among the plurality of groups, display icons that belong to the specific group and icons that do not belong to the specific group among the plurality of icons in the icon display area in such a manner that the icons belonging to the specific group and the icons that do not belong to the specific group are displaced from each other in a direction perpendicular to the predetermined direction.

12. The image forming apparatus according to claim 1, wherein
the display control unit is configured to, upon again receiving a user operation on a string of icons or a slider for specifying the some icons within the specified range of the predetermined width in the icon display area after a transition from a first display state to a second display state, perform a transition operation of causing a transition from the second display state to the first display state, the first display state being a state in which some function buttons corresponding to the some icons are displayed in the function button display area, and the second display state being a state in which function buttons belonging to the specific group specified by the input of the group display instruction are displayed in the function button display area.

13. The image forming apparatus according to claim 1, wherein
the display control unit is configured to, upon again receiving the input of the group display instruction to the specific group through the group display instruction area after a transition from a first display state to a second display state, perform a transition operation of causing a transition from the second display state to the first display state, the first display state being a state in which some function buttons corresponding to the some icons are displayed in the function button display area, and the second display state being a state in which function buttons belonging to the specific group specified by the input of the group display instruction are displayed in the function button display area.

14. The image forming apparatus according to claim 1, wherein
the display control unit is configured to, upon completion of a function setting operation performed in response to pressing of a specific function button belonging to the specific group after a transition from a first display state to a second display state, perform a transition operation of causing a transition from the second display state to the first display state, the first display state being a state in which some function buttons corresponding to the some icons are displayed in the function button display area, and the second display state being a state in which function buttons belonging to the specific group specified by the input of the group display instruction are displayed in the function button display area.

15. The image forming apparatus according to claim 1, wherein
the display control unit is configured to, when a no-operation period continues for a predetermined period of time after a transition from a first display state to a second display state, perform a transition operation of causing a transition from the second display state to the first display state, the first display state being a state in which some function buttons corresponding to the some icons are displayed in the function button display area, and the second display state being a state in which function buttons belonging to the specific group specified by the input of the group display instruction are displayed in the function button display area.

16. A non-transitory computer-readable recording medium recording a program for causing a computer to execute:
a) displaying a setting screen that includes an icon display area, a function button display area, and a group display instruction area,
the icon display area displaying a plurality of icons that are arranged in a predetermined direction and correspond to a plurality of function buttons for setting each function,
the function button display area displaying one or more of the plurality of function buttons, and
the group display instruction area receiving input of a group display instruction to display function buttons that belong to one of a plurality of groups for classifying the plurality of function buttons, in the function button display area;
b) receiving the input of the group display instruction to the group display instruction area in a first display state in which some function buttons that correspond to some icons within a specified range of a predetermined width among the plurality of icons arranged in the predetermined direction in the icon display area are displayed in the function button display area; and
c) in response to the input of the group display instruction, performing a transition operation of causing a transition to a second display state in which function buttons belonging to a specific group specified by the input of the group display instruction are displayed in the function button display area.

17. A method for controlling an image forming apparatus, comprising:
a) displaying a setting screen that includes an icon display area, a function button display area, and a group display instruction area,
the icon display area displaying a plurality of icons that are arranged in a predetermined direction and correspond to a plurality of function buttons for setting each function,
the function button display area displaying one or more of the plurality of function buttons, and
the group display instruction area receiving input of a group display instruction to display function buttons that belong to one of a plurality of groups for classifying the plurality of function buttons, in the function button display area;
b) receiving the input of the group display instruction to the group display instruction area in a first display state in which some function buttons that correspond to some icons within a specified range of a predetermined width among the plurality of icons arranged in the predetermined direction in the icon display area are displayed in the function button display area; and
c) in response to the input of the group display instruction, performing a transition operation of causing a transition to a second display state in which function buttons belonging to a specific group specified by the input of the group display instruction are displayed in the function button display area.
